(19) United States
(12) Patent Application Publication
(10) Pub. No.: US 2026/0213797 A1
(43) Pub. Date: Jul. 23, 2026

(54) MULTIMODAL COMPOSITE CARRIER TRANSMISSION METHOD AND SYSTEM

(71) Applicant: Minghsin University of Science and Technology, Xinfeng Township (TW)

(72) Inventor: Ke-Ren CHEN, Changhua City (TW)

(73) Assignee: Minghsin University of Science and Technology, Xinfeng Township (TW)

(21) Appl. No.: 19/027,597

(22) Filed: Jan. 17, 2025

(51) Int. Cl. H04B 7/0413; H04L 5/00

(52) U.S. Cl. CPC H04B 7/0413; H04L 5/0092

(57) ABSTRACT

The present invention relates to a multimodal composite carrier transmission method and system, wherein the signal transmitting end adaptively adjusts the frequency, time, and phase angles of carriers to form a plurality of multimodal composite subcarriers. The signal transmitting end modulates the data to be transmitted onto a plurality of multimodal composite subcarriers and further modulates the plurality of multimodal composite subcarriers into a plurality of multimodal composite carriers for transmission. The signal receiving end demodulated data from the plurality of multimodal composite carriers to achieve the purpose of improving transmission performance.

### FIELD OF THE INVENTION

The present invention relates to a transmission method and system, particularly a multimodal composite carrier transmission method and system in which carriers are mixed using frequency, time, and phase angles.

### BACKGROUND OF THE INVENTION

From 3.5th Generation Mobile Communication Technology (3.5G), also known as High-Speed Downlink Packet Access (HSDPA), to the 4th Generation Mobile Communication Technology (Long-Term Evolution, LTE), and further evolving into the current 5th Generation Mobile Communication Technology (5G), improvements in transmission speed have been achieved. However, these improvements stem primarily from advances in hardware processing speed and the adoption of carrier aggregate (CA) by telecom operators. CA technology aggregates the existing fragmented spectrum into a virtual contiguous spectrum, optimizing transmission performance. Nevertheless, from the perspective of spectral efficiency, the improvements from the 3.5th to the 5th generation communication systems are not significant, as both rely on orthogonal frequency division multiplexing (OFDM) or Multi-Input Multi-Output (MIMO) combined with OFDM architecture at the physical layer.

In 4G, the increase in transmission speed is largely attributed to telecom operators obtaining larger bandwidths and applying carrier aggregation to expand channel resources, rather than improving spectral efficiency per unit. It means that the spectral utilization efficiency of 4G remains similar to that of 3.5G, with no breakthrough advancement.

According to the International Telecommunication Union (ITU) white paper on 5G technology, traditional multicarrier modulation remains dominant in the physical layer of 5G, indicating that the waveform design still relies on technologies inherited from 3.5G. However, the 5G ITU requires that the waveform achieve at least three times the spectral efficiency, a demand that existing technologies struggle to meet. To compensate for this deficiency, telecom operators are forced to bid for more spectrum resources, leading to increased operational costs and inefficient investments.

In other words, achieving higher spectral efficiency and meeting the demands of 5G transmissions will only be possible with improvements to existing MIMO technologies. The industry urgently needs a breakthrough waveform technology to enhance spectral utilization efficiency. Despite various technological improvements proposed for 5G and even 6th Generation Mobile Communication Technology (6G) waveform developments, most solutions continue to rely on narrowband OFDM designs, which present significant limitations. The current technical developments and their constraints are summarized as follows:

(1) Enhanced Orthogonal Frequency Division Multiplexing (e-OFDM):

e-OFDM builds on traditional OFDM, aiming to support ultrahigh data rates and low-latency demands. It dynamically adjusts transmission rates based on channel conditions by introducing large-scale digital and adaptive modulation. Additionally, it emphasizes the collaborative use of OFDM with other waveforms, such as non-orthogonal multiple access (NOMA), to enhance system stabilities. However, e-OFDM continues to rely on narrowband OFDM waveforms, and its large-scale modulation remains constrained to a single-layer frame in a planar configuration, failing to break through the spectral efficiency bottleneck.

### (2) Unipolar OFDM for Ultra-High Frequency Bands:

This technology focuses on dynamic resource allocation and scheduling among multiple carriers to improve spectral utilization efficiency in adverse frequency bands. However, it still adopts narrowband OFDM waveforms and faces challenges in maintaining orthogonality and achieving efficient bandwidth usage in high-frequency bands.

### (3) Non-Orthogonal Multiple Access (NOMA):

NOMA achieves non-orthogonal multiplexing of multi-user signals in the power domain, breaking traditional time, frequency, or multicarrier limitations. By assigning different power levels at the transmitter and applying successive interference cancelation (SIC) at the receiver, NOMA converts channel gain differences into multi-user capacity and fairness. However, this technique focuses only on power transformation without overcoming the limitations of narrow-band OFDM.

### (4) Adaptive Waveform Technologies:

Adaptive waveform technologies dynamically adjust waveform characteristics according to communication environments, making them suitable for complex scenarios. In particular, they integrate high-frequency bands (e.g., millimeter waves and terahertz waves) with improved OFDM technologies. However, the adaptive effectiveness of such systems in adverse high-frequency environments still needs to be improved, as demonstrated by the implementation of Samsung Electronics.

### (5) Magneto-Optical Technology:

In the 6G waveform research, China Unicorn and ZTE proposed using magneto-optical waveforms, specifically designed for inter-base station optical communication in ultra-high frequency bands. However, the Magneto-optical technology approach remains grounded in narrowband OFDM technology and is restricted to specific application scenarios.

### (6) Combination of Orthogonal and Non-Orthogonal Multiplexing:

Combining OFDM with non-orthogonal multiple access (NOMA) enhances multi-user access capability and improves spectral efficiency in large-scale deployments. However, the overall efficiency remains limited when orthogonal and non-orthogonal technologies operate on the same frame in a planar configuration.

In summary, although various existing technologies have made improvements, they still adhere to the narrowband OFDM architecture and fail to overcome the limitations of spectral efficiency. Therefore, without improving traditional waveform technologies, it is impossible to effectively enhance spectral efficiency or meet the transmission demands of 5G and even 6G communications. In other words, to break through the bottleneck of spectral efficiency in the future, it is necessary to abandon the conventional concepts of previous waveform technologies and adopt a groundbreaking waveform technology to improve spectral utilization efficiency.

### SUMMARY OF THE INVENTION

In view of the problems of the prior art, the objective of the present invention is to provide a multimodal composite carrier transmission technology applicable to conventional carrier technologies such as orthogonal multiplexing and non-orthogonal multiplexing for multicarrier transmission, thereby improving the spectral efficiency of communication systems.

To achieve the objectives of the present invention, a multimodal composite carrier transmission method is provided, which is applied to a signal transmitting end. The method comprises adaptively adjusting frequency modes, time modes, phase angle modes, and subcarrier mode numbers of a plurality of subcarriers to form a plurality of multimodal composite subcarriers. The signal transmitting end modulates the data to be transmitted onto the plurality of multimodal composite subcarriers and further modulates the plurality of multimodal composite subcarriers into a plurality of multimodal composite carriers for transmission, wherein the frequency modes, time modes, phase angle modes, and carrier mode numbers of the plurality of multimodal composite carriers are also adjusted according to adaptive conditions.

The multimodal composite carrier transmission method further comprises generating synchronization information at the signal receiving end, receiving the synchronization information, and adjusting the frequency mode, time mode, and phase angle mode of the multimodal composite carriers based on the synchronization information. The synchronization information comprises time delay, frequency offset, and phase offset.

Wherein, when the signal transmitting end and the signal receiving end are communication devices with a multi-input multi-output (MIMO) antenna architecture, the total transmission capacity is the product of the number of antennas in the MIMO architecture and the total number of modes of the signal transmitting end. The product of the carrier mode numbers and the subcarrier mode numbers constitute the total number of modes.

To further achieve the objectives of the present invention, a multimodal composite carrier transmission system is provided, which comprises a signal transmitting end and a signal receiving end. The signal transmitting end is connected to the signal receiving end and adaptively adjusts a frequency mode, a time mode, a phase angle mode, and subcarrier mode numbers of a plurality of subcarriers to form a plurality of multimodal composite subcarriers. The signal transmitting end modulates the data to be transmitted onto the plurality of multimodal composite subcarriers and further modulates the plurality of multimodal composite subcarriers into a plurality of multimodal composite carriers for transmission, wherein the frequency modes, time modes, phase angle modes, and carrier mode numbers of the plurality of multimodal composite carriers are also adjusted according to adaptive conditions. The signal receiving end receives the plurality of multimodal composite carriers, demodulates them into a plurality of multimodal composite subcarriers, and further demodulates the multimodal composite subcarriers into data.

The signal transmitting end and the signal receiving end are communication devices that utilize a multi-input multi-output (MIMO) antenna architecture.

As described above, the present invention effectively utilizes the carrier phase resources between the signal transmitting end and the signal receiving end, significantly improving the spectral efficiency to meet future high-speed communication demands. By combining orthogonal and/or non-orthogonal multimodal technologies, the invention achieves both high performance and high compatibility, providing an excellent solution for the wireless communication field.

### BRIEF DESCRIPTION OF DRAWINGS

FIG. 1 is a flow chart illustrating the steps of the present invention applied to a signal transmitting end.

FIG. 2 is a flow chart that illustrates the steps of the present invention applied to a signal receiving end.

FIG. 3 is a schematic diagram showing the multimodal composite subcarriers of the present invention as orthogonal frequency division multiplexing (OFDM) in a non-coherent mode with frequency, time, and phase.

FIG. 4 is a Keren Map illustrating the multimodal composite subcarriers of the present invention as orthogonal frequency division multiplexing in a non-coherent mode, where the subcarrier mode number is 4.

FIG. 5 is a Keren Map illustrating the multimodal composite subcarriers of the present invention as non-orthogonal frequency division multiplexing in a non-coherent mode, where the subcarrier mode numbers are 1, 2, 4, 8, and 16.

FIG. 6 is a Keren Map illustrating the multimodal composite subcarriers of the present invention as orthogonal frequency-division multiplexing in a non-coherent mode, where the subcarrier mode numbers are 1, 2, 4, 8, and 16.

FIG. 7 is a schematic diagram comparing the Keren map of the 2-ANM, 8-ANM, and traditional orthogonal frequency division multiplexing (OFDM).

FIG. 8 is a schematic diagram that compares the Keren map and the IQ chart of the present invention.

FIG. 9 is a schematic diagram illustrating different phases that transmit different services in the present invention.

FIG. 10 is a schematic diagram of the plurality of multimodal composite carriers transmission systems of the present invention.

FIG. 11 is a schematic diagram of the signal transmitting end of the present invention.

FIG. 12 is a schematic diagram of the signal receiving end of the present invention.

FIG. 13 is a schematic diagram of FIG. 12 with the addition of a channel estimation module, synchronization module, and reconfigurable module.

FIG. 14 is a schematic diagram of FIG. 11 with the addition of a MIMO coding module and a plurality of first antennas.

FIG. 15 is a schematic diagram of FIG. 12 with the addition of a MIMO decoding module and a plurality of second antennas.

FIG. 16 is a schematic diagram of FIG. 13 with the addition of a channel estimation module, synchronization module, reconfigurable module, MIMO decoding module, and a plurality of second antennas.

FIG. 17 is a schematic diagram of FIG. 11 with the addition of a first serial-to-parallel module.

FIG. 18 is a schematic diagram of a modulation module that comprises the n first communication modulation chips.

FIG. 19 is a schematic diagram of FIG. 17 with the addition of a first parallel-to-serial module and a cyclic prefix module.

FIG. 20 is a schematic diagram of FIG. 12 with the addition of a cyclic prefix removal module and a second serial-to-parallel module.

FIG. 21 is a schematic diagram of a demodulation module including n second communication modulation chips.

FIG. 22 is a schematic diagram of FIG. 20 with the addition of a second parallel-to-serial module.

### DETAILED DESCRIPTION OF THE INVENTION

The embodiments of the present invention will be explained further with reference to the accompanying drawings. Where possible, identical or similar reference numerals are used in the drawings and the description to represent the same or similar components. For simplicity and clarity, shapes and thicknesses in the drawings may be exaggerated. It is understood that elements not specifically shown in the drawings or described in the specification are assumed to be in form well known to those skilled in the art. Various modifications and changes can be made to the invention on its content by persons skilled in the art.

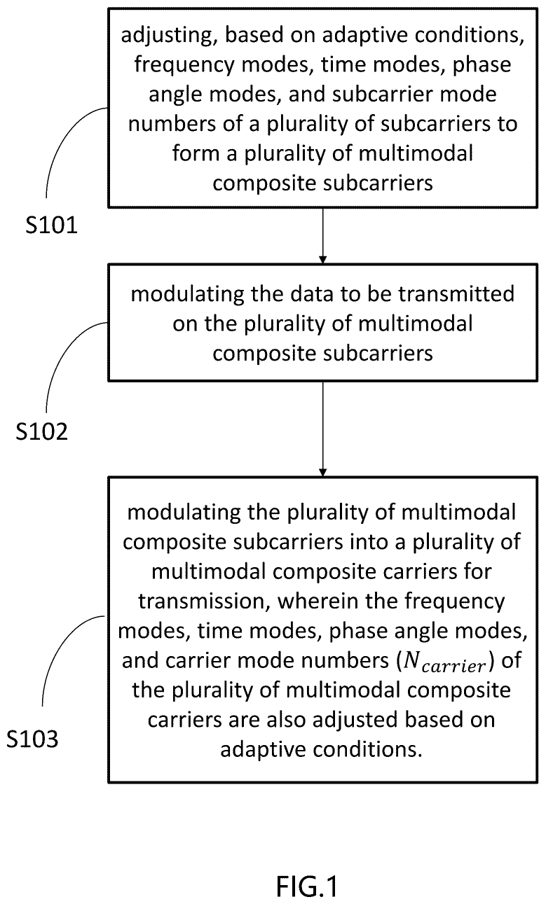

Refer to FIG. 1, which illustrates a multimodal composite carrier transmission method of the present invention applied to a signal transmitting end, including the following steps:
(S101) adjusting, based on adaptive conditions, frequency modes, time modes, phase angle modes, and subcarrier mode numbers of a plurality of subcarriers to form a plurality of multimodal composite subcarriers, where the subcarrier mode number (N_{sub}) can be expressed by the following formula:

$${N}_{sub} = {N}_{sub\_f} \times {N}_{sub\_t} \times {N}_{sub \_θ}$$

wherein, the number of frequency mode (N_{f}) is determined by the frequency allocation range and frequency spacing

$$( {N}_{sub\_f} = \frac{Bandwidth}{∇ f} ) ,$$

the number of time mode (N_{sub_t}) is determined by the symbol period (Tₛ) and the total time window

$$( {N}_{sub\_t} = \frac{TotalTime )}{{T}_{s}} ) ,$$

and the number of phase angle mode (N_{sub_θ}) depends on the discretization level of the phase

$$( {N}_{sub \_θ} = \frac{Phase Range}{Adjacent Phase Interval} ) ;$$

(S102) modulating the data to be transmitted on the plurality of multimodal composite subcarriers;
(S103) modulating the plurality of multimodal composite subcarriers into a plurality of multimodal composite carriers for transmission, wherein the frequency modes, time modes, phase angle modes, and carrier mode numbers (N_{carrier}) of the plurality of multimodal composite carriers are also adjusted based on adaptive conditions. The product of the subcarrier mode numbers, and the carrier mode numbers (N) constitute the total number of modes, which can be expressed as follows:

$$N = {N}_{sub} \times {N}_{carrier} ∘$$

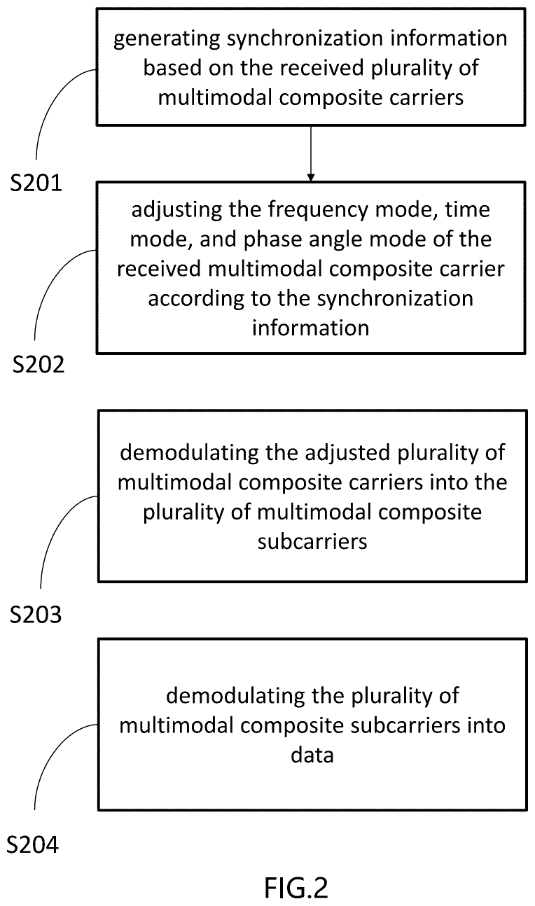

Please refer to FIG. 2, which shows an embodiment of the present invention applied to a signal receiving end, including the following steps:
(S201) generating synchronization information based on the received plurality of multimodal composite carriers;
(S202) adjusting the frequency mode, time mode, and phase angle mode of the received multimodal composite carrier according to the synchronization information;
(S203) demodulating the adjusted plurality of multimodal composite carriers into the plurality of multimodal composite subcarriers;
(S204) demodulating the plurality of multimodal composite subcarriers into data.

In some embodiments of the present invention, in a baseband module of the modulator at the signal transmitting end, data is modulated onto a plurality of baseband multimodal composite subcarriers, where the mode number of the baseband module (N_{bf}) is expressed as follows:

$${N}_{bf} = {N}_{bf\_f} \times {N}_{bf\_t} \times {N}_{bf \_θ}$$

where N_{bf_f} represents the number of frequency mode of the baseband module, N_{bf_t} represents the number of time mode of the baseband module, and N_{bf_θ} represents the number of phase angle mode of the baseband module. N_{bf} is equal to 2^{α}, where α is a positive integer greater than or equal to 1. The mode number of the baseband module (N_{bf}) is equivalent to the subcarrier mode number N_{sub} of the multimodal composite subcarriers.

In an intermediate frequency (IF) module of the modulator, the baseband multimodal composite subcarriers are modulated into a plurality of IF multimodal composite carriers, typically through frequency up-conversion. The mode number of the IF module N_{if} is expressed as follows:

$${N}_{if} = {N}_{if\_f} \times {N}_{if\_t} \times {N}_{if \_θ}$$

where N_{if_f} represents the number of frequency mode of the IF module, N_{if_t} represents the number of time mode of the IF module, and N_{if_θ} represents the number of phase angle mode of the IF module. N_{if} is equal to 2^{β}, where β is zero or a positive integer greater than or equal to 1.

In a radio frequency (RF) module of the modulator, the IF multimodal composite carriers are modulated into a plurality of RF multimodal composite carriers to meet the requirements of antennas and wireless transmission. The mode number of the RF module N_{rf} is expressed as follows:

$${N}_{rf} = {N}_{rf\_f} \times {N}_{rf\_t} \times {N}_{rf \_θ}$$

where N_{if_f} represents the number of frequency mode of the RF module, N_{if_t} represents the number of time mode of the RF module, and N_{if_θ} represents the number of phase angle mode of the RF module. N_{rf} is equal to 2^{γ}, where γ is zero or a positive integer greater than or equal to 1.

The product of the mode number of the RF module (N_{rf}) and the mode number of the IF module (N_{if_f}) constitutes the carrier mode number (N_{carrier}) of the plurality of multimodal composite carriers. Therefore, the carrier mode number (N_{carrier}) of the plurality of multimodal composite carriers can be rewritten as the following expression:

$${N}_{carrier} = {N}_{if} \times {N}_{rf}$$

Accordingly, the total number of modes (N) can be rewritten as the following expression:

$$N = {N}_{bf} \times {N}_{if} \times {N}_{rf}$$

As described above, when the baseband module, IF module, and RF module can individually adjust their frequency mode, time mode, and phase angle mode, the total number of modes (N) is the product of all mode numbers. The specific mode numbers of the baseband module (N_{bf}), IF module (N_{if}), and RF module (N_{rf}) are determined based on adaptive conditions.

Generally, the baseband multimodal composite subcarriers are the multimodal composite subcarriers, while the RF multimodal composite carriers are the plurality of multimodal composite carriers. The mode number of the baseband module (N_{bf}) typically has the greatest impact on the total number of modes (N), as the data is modulated onto the baseband multimodal composite subcarriers. The structure of the baseband multimodal composite subcarriers is retained in the IF multimodal composite carriers and the RF multimodal composite carriers. However, from an external perspective, the IF multimodal composite carriers and the RF multimodal composite carriers are usually regarded as single carrier signals. Moreover, the IF and RF multimodal composite carriers generally undergo frequency up conversion. As a result, the frequency mode (N_{if_f}, N_{rf_f}) and time mode (N_{if_t}, N_{rf_t}) of the IF and RF multimodal composite carriers remain fixed, with only the phase mode (N_{if_θ}, N_{rf_θ}) varying. Therefore, the total number of modes can be further expressed as follows:

$$N = {N}_{bf} \times {N}_{if \_θ} \times {N}_{rf \_θ}$$

At this point, the IF module divides the baseband multimodal composite subcarriers into different groups and modulates each group into different phase mode of the IF multimodal composite carriers. Alternatively, the IF module modulates the entire baseband multimodal composite subcarriers onto different phase modes of the IF multimodal composite carriers. The RF module can further modulate each IF multimodal composite carrier onto different phase modes of the RF multimodal composite carriers. However, the implementation of the present invention is not limited to these configurations.

Considering signal stability and circuit structure cost, the phase mode of the IF multimodal composite carriers and RF multimodal composite carriers can remain unchanged. In such cases, the total number of modes is revised as follows:

$$N = {N}_{bf} = {N}_{bf\_f} \times {N}_{bf\_t} \times {N}_{bf \_θ}$$

In some embodiments of the present invention, the adaptive conditions of the signal transmitting end are based on channel estimation of the transmission channel. The results of the channel estimation are used to adjust the frequency modes, time modes, phase angle modes, and subcarrier mode numbers of the plurality of subcarriers (baseband multimodal composite subcarriers). For example, these adjustments can be applied to subcarriers in orthogonal frequency-division multiplexing (OFDM) or non-orthogonal frequency-division multiplexing (NOFDM). Furthermore, the frequency modes, time modes, phase angle modes, and carrier mode numbers of the IF multimodal composite carriers and RF multimodal composite carriers can also be adjusted accordingly.

In some embodiments, channel estimation methods comprise pilot symbol aided estimation (PSAE), blind estimation (BE), time domain channel estimation, frequency domain channel estimation, time-frequency joint channel estimation, channel interpolation estimation, least squares estimation (LSE), minimum mean square error estimation (MMSEE), or artificial intelligence model evaluation. For example:
Pilot symbol aided estimation utilizes known transmitted signals as the basis for the estimation.
Blind estimation uses the structural characteristics of signals for estimation.
Time domain channel estimation directly estimates the channel impulse response in the time domain.
Frequency domain channel estimation estimates the channel frequency response in the frequency domain, particularly suitable for multi-carrier systems.
Time-frequency joint channel estimation uses both time and frequency domain characteristics for channel estimation.
Channel interpolation estimation uses pilot symbol information and applies interpolation algorithms such as linear interpolation, spline interpolation, or DFT interpolation.
Least squares estimation minimizes the sum of squared errors between the received signal and pilot signals.
Minimum mean-square error estimation minimizes the mean squared error between the estimated channel value and the true channel value.

In some embodiments, channel estimation is performed by evaluating the aforementioned pilot symbol-aided estimation, blind estimation, time domain channel estimation, frequency domain channel estimation, time-frequency joint channel estimation, channel interpolation estimation, least squares estimation, minimum mean-square error estimation, or quality of service (QoS) using an artificial intelligence model. The QoS may comprise any one or more combinations of received signal strength indicator (RSSI), signal-to-noise ratio (SNR), signal-to-interference-plus-noise ratio (SINR), reference signal received power (RSRP), reference signal received quality (RSRQ), bit error rate (BER), packet error rate (PER), and packet drop rate (PDR). Alternatively, the type of channel estimation can be determined based on the mobility speed between the signal transmitting end and the signal receiving end to calculate the subcarrier mode numbers of the multimodal composite subcarriers. Alternatively, the signal transmitting end can dynamically compute the subcarrier mode numbers of the multimodal composite subcarriers through cross-layer communication protocols or allocate the mode quantities for baseband multimodal composite subcarriers, IF multimodal composite carriers, and RF multimodal composite carriers, to maintain stable communication quality.

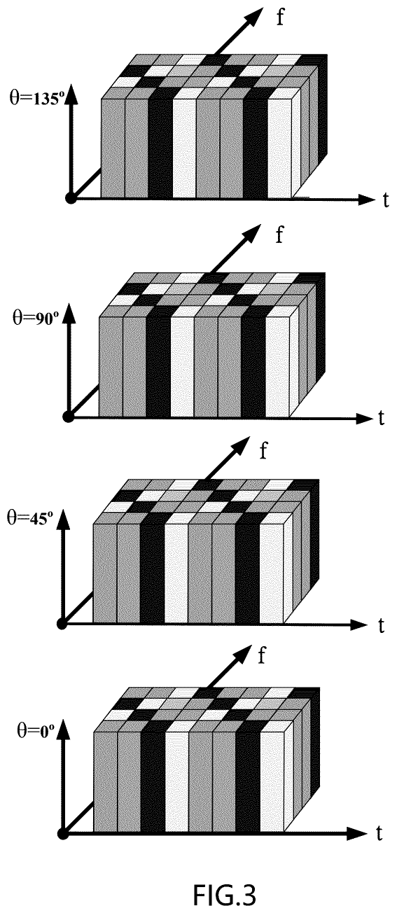

As shown in FIG. 3, in some embodiments, the plurality of multimodal composite subcarriers may have the same frequency mode, the same time mode, and different phase angle modes. Alternatively, the multimodal composite subcarriers may operate in frequency orthogonal modes, continuous time orthogonal interval modes, and different phase angle modes, which correspond to orthogonal frequency-division multiplexing in non-coherent modes. Furthermore, the multimodal composite subcarriers may operate in frequency non-orthogonal modes, continuous time interval modes, and different phase angle modes, corresponding to non-orthogonal frequency-division multiplexing in non-coherent modes.

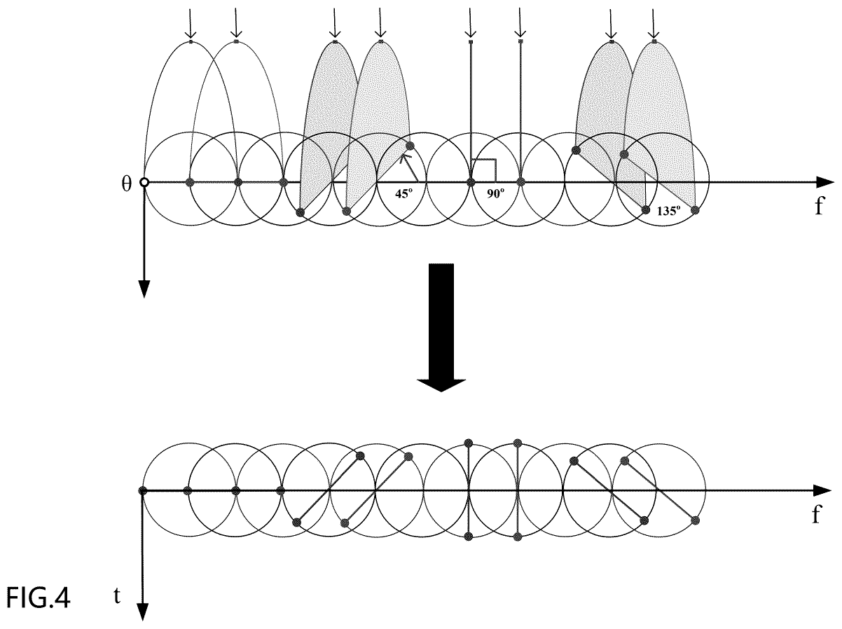

As shown in FIG. 4, the phase variations of the multimodal composite subcarriers in the frequency and time domains are projected as a Keren Map. The Keren Map simplifies the complex three-dimensional spectral diagram (main lobe of sinc functions) into an intuitive two-dimensional projection. In the Keren Map, each multimodal composite subcarrier has the same amplitude and frequency but different phase angles, and these subcarriers are mutually orthogonal in the spectrum. The frequency-time (f-t) projection clearly shows the structural changes of the multimodal composite subcarriers. The Keren Map can be applied to communication protocol designs to monitor and analyze phase changes. Using the Keren Map, communication protocols can dynamically adjust the phase angle distribution of the multimodal composite subcarriers, i.e., the subcarrier mode numbers, to optimize the design of the physical layer waveform and ensure stability and efficiency of communication quality.

Because the Keren Map simplifies the complex three-dimensional spectrum into an intuitive two-dimensional diagram, it serves as an effective visual tool for real-time optimization in cross-layer communication protocols, particularly for communication quality control in high-dynamic environments. For example, when the subcarrier mode numbers is four, the phase angle modes are 0°, 45°, 90°, and 135°, which are clearly illustrated in the Keren Map. This enables easy verification, analysis, and observation of the orthogonality characteristics of each multimodal composite subcarrier.

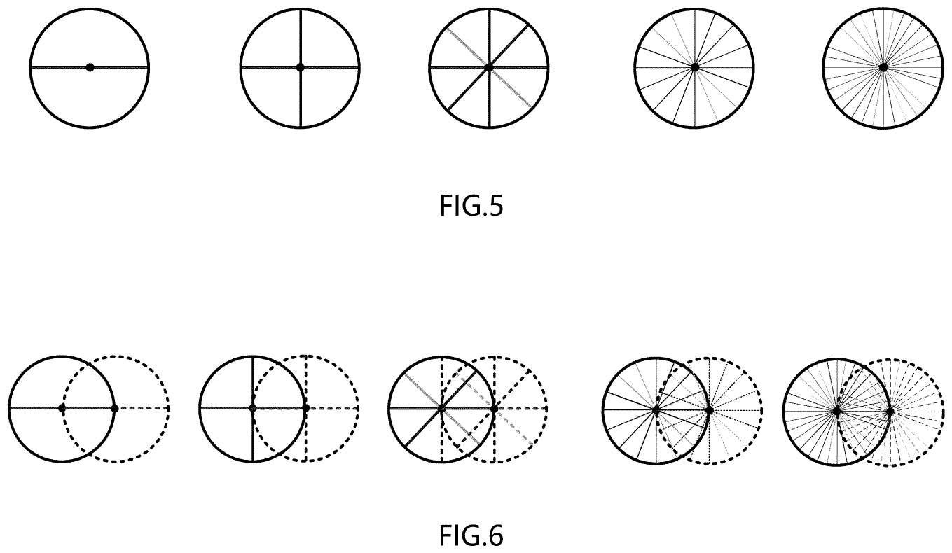

As shown in FIGS. 5 and 6, the plurality of multimodal composite subcarriers may operate in either non-orthogonal frequency-division multiplexing in non-coherent modes (referred to as ANM) or orthogonal frequency-division multiplexing in non-coherent modes (referred to as AOM). When the subcarrier mode numbers are denoted as N_{bf}, they are referred to as N_{bf}-ANM and N_{bf}-AOM, respectively. The waveform variations of N_{bf}-ANM and N_{bf}-AOM are represented in the Keren Map, exhibiting the phase offset characteristics of different subcarriers.

When N_{bf}=1, the subcarrier phase offset is 0° for both 1-ANM and 1-AOM waveforms (FIG. 5 leftmost and FIG. 6 leftmost), and the phase characteristics remain identical in the Keren Map. In FIG. 6, the leftmost waveform is composed of two 1-AOM waveforms that are mutually orthogonal.

When N_{bf}=2, the subcarrier phase offset is 90° for 2-ANM and 2-AOM waveforms (FIG. 5 second from left and FIG. 6 second from left), and FIG. 6 shows two 2-AOM waveforms that are mutually orthogonal.

When N_{bf}=4, the subcarrier phase offset is 45° for 4-ANM and 4-AOM waveforms (FIG. 5 third from left and FIG. 6 third from left), with two 4-AOM waveforms in FIG. 6 forming mutual orthogonality.

When N_{bf}=8, the subcarrier phase offset is 22.5° for 8-ANM and 8-AOM waveforms (FIG. 5 fourth from left and FIG. 6 fourth from left), and two 8-AOM waveforms in FIG. 6 are mutually orthogonal.

Finally, when N_{bf}=16, the subcarrier phase offset is 11.25° for 16-ANM and 16-AOM waveforms (FIG. 5 rightmost and FIG. 6 rightmost), where two 16-AOM waveforms in FIG. 6 are mutually orthogonal.

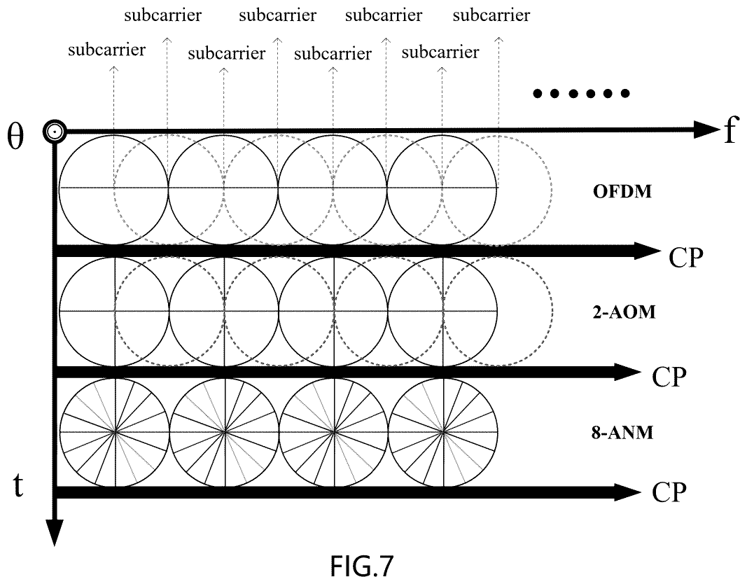

As shown in FIG. 7, the 2-ANM and 8-ANM waveforms are compared with the traditional orthogonal frequency-division multiplexing (OFDM) waveforms. The Keren Map clearly reveals the significant improvement in total spectral efficiency.

In some embodiments, the total number of mode is adjusted based on the quality of the result of the channel estimation, such that better the results of channel estimation lead to higher the subcarrier mode numbers or the total number of mode, whereas poorer the results of channel estimation lead to lower the subcarrier mode numbers or the total number of mode.

In some embodiments, the plurality of multimodal composite subcarriers with the same frequency mode, the same time mode, and different phase angle mode, the phase interval for each phase angle mode is represented by the following formula:

$${phash}_{angle} = \frac{180 °}{{N}_{bf \_θ}}$$

Where phash_{angle} represents the phase interval, and N_{bf_θ} represents the number of phase mode in the subcarrier mode numbers of the multimodal composite subcarriers.

In some embodiments, the frequency mode of the plurality of multimodal composite subcarriers is configured by dividing a specified bandwidth into different subbands, and arranging different transmission time intervals, subcarrier phase angle intervals, and cyclic prefixes.

In some embodiments, the subcarrier mode numbers of the multimodal composite subcarriers can be adaptively adjusted based on the channel estimation result. When the channel experiences severe attenuation, the system may fall back to OFDM modes (e.g., 1-AOM), or in extreme cases, the system switches to non-orthogonal frequency-division multiplexing in non-coherent modes.

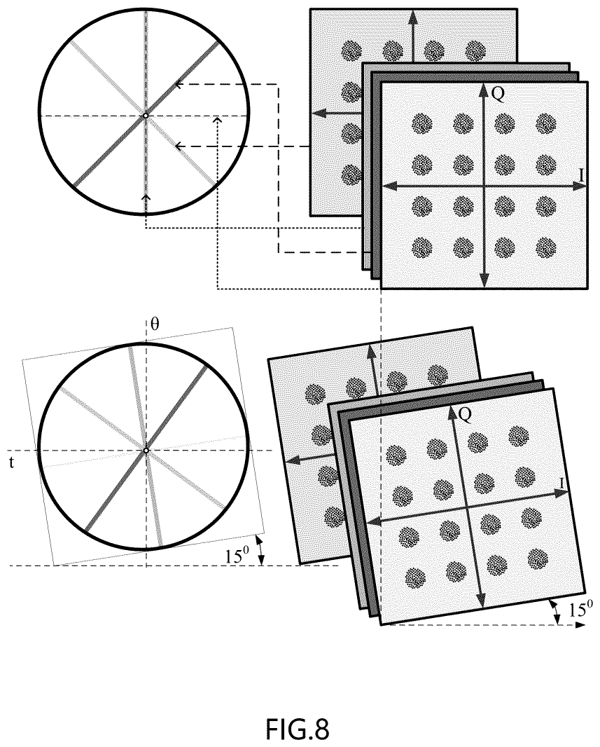

As shown in FIG. 8, one of the key functionalities of the Keren Map is to assist the signal receiving end in detecting phase offset problems in the IQ diagram (in-phase-quadrature, also known as the constellation diagram), particularly in 6G operating at terahertz and millimeter-wave frequency bands, where channel quality degradation causes high bit error rates (BER). By monitoring rotational offsets in the Keren Map and combining quality of service (QoS) indicators, the subcarrier mode numbers can be adaptively adjusted, or the total number of modes can be applied for dynamic optimization. The Keren Map not only serves as a real-time demodulation monitoring indicator but is also applied during channel estimation using artificial intelligence models (e.g., convolutional neural networks) to sense all sensitive channel factors (e.g., QoS indicators). This assists communication protocols in making optimal decisions, thereby effectively addressing the bottleneck problems proposed by the International Telecommunication Union (ITU) for 5G and 6G communication systems.

In some embodiments, synchronization information at the signal receiving end enables accurate detection of the symbol starting position (time synchronization), carrier frequency offset (frequency synchronization), and phase drift, thereby adjusting the frequency mode, time mode, and phase mode of the plurality of multimodal composite carriers. This ensures efficient demodulation of the data from the plurality of multimodal composite carriers, achieving improved transmission performance. At the signal receiving end, the synchronization information is generated based on the results of the channel estimation (channel estimation information).

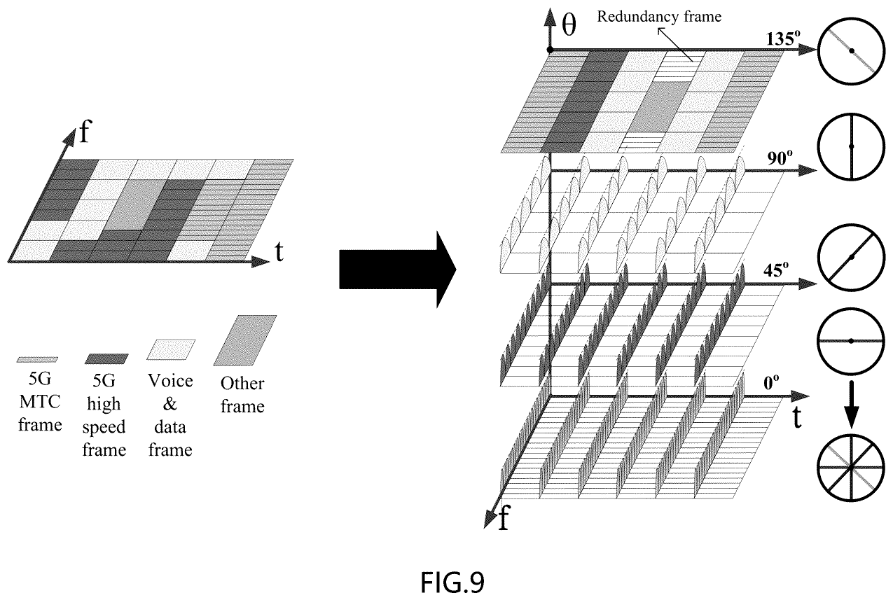

As shown in FIG. 9, in some embodiments, the frames of the multimodal composite subcarriers are designed to transmit the same service within the same phase plane as much as possible. Alternatively, the frames of the same phase plane can transmit different services by introducing redundant frames, which carry Keren Map control data to enhance system stability and reduce latency.

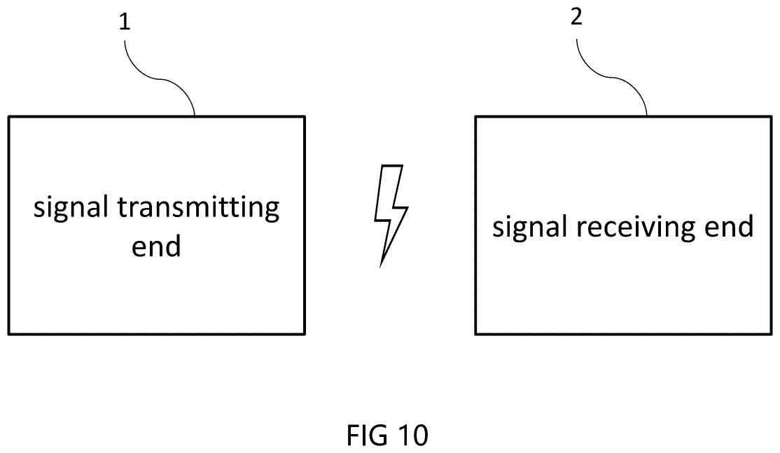

As shown in FIG. 10, the multimodal composite carrier transmission system of the present invention comprises a signal transmitting end 1 and a signal receiving end 2. The signal transmitting end 1 adaptively adjusts the frequency modes, time modes, phase angle modes, and subcarrier mode numbers of a plurality of subcarriers to form a plurality of multimodal composite subcarriers. The signal transmitting end 1 modulates the data to be transmitted onto the plurality of multimodal composite subcarriers and modulates the multimodal composite subcarriers into a plurality of multimodal composite carriers for transmission. The signal receiving end 2 receives the plurality of multimodal composite carriers, demodulates the plurality of multimodal composite carriers into the plurality of multimodal composite subcarriers, and further demodulates the plurality of multimodal composite subcarriers into data.

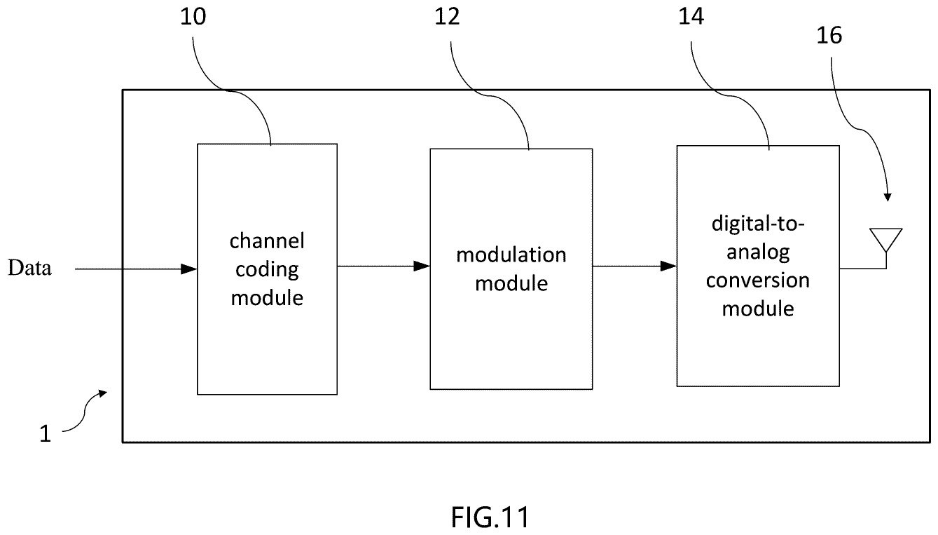

In some embodiments, as shown in FIG. 11, the signal transmitting end 1 comprises a channel coding module 10, a modulation module 12, a digital-to-analog conversion module 14, and a first antenna 16. The channel coding module 10 receives data and encodes them into channel encoded data. The modulation module 12, connected to the channel coding module 10, modulates the channel encoded data onto the plurality of multimodal composite subcarriers and further modulates the multimodal composite subcarriers into a plurality of digital multimodal composite carriers. The digital-to-analog conversion module 14, connected to the modulation module 12, converts the plurality of digital multimodal composite carriers into a plurality of analog multimodal composite carriers. The first antenna 16, connected to the digital-to-analog conversion module 14, transmits the analog multimodal composite carriers.

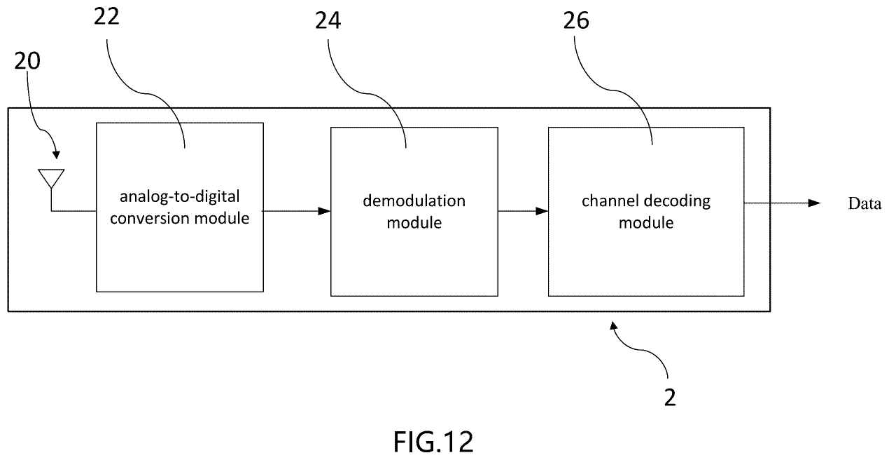

As shown in FIG. 12, the signal receiving end 2 comprises a second antenna 20, an analog-to-digital conversion module 22, a demodulation module 24, and a channel decoding module 26. The second antenna 20 receives the plurality of analog multimodal composite carriers. The analog-to-digital conversion module 22, connected to the second antenna 20, converts the plurality of analog multimodal composite carriers into the plurality of digital multimodal composite carriers. The demodulation module 24, connected to the analog-to-digital conversion module 22, demodulates the plurality of digital multimodal composite carriers into the plurality of digital multimodal composite subcarriers and further demodulates the plurality of digital multimodal composite subcarriers into channel encoded data. The channel decoding module 26 decodes the channel encoded data into the original data.

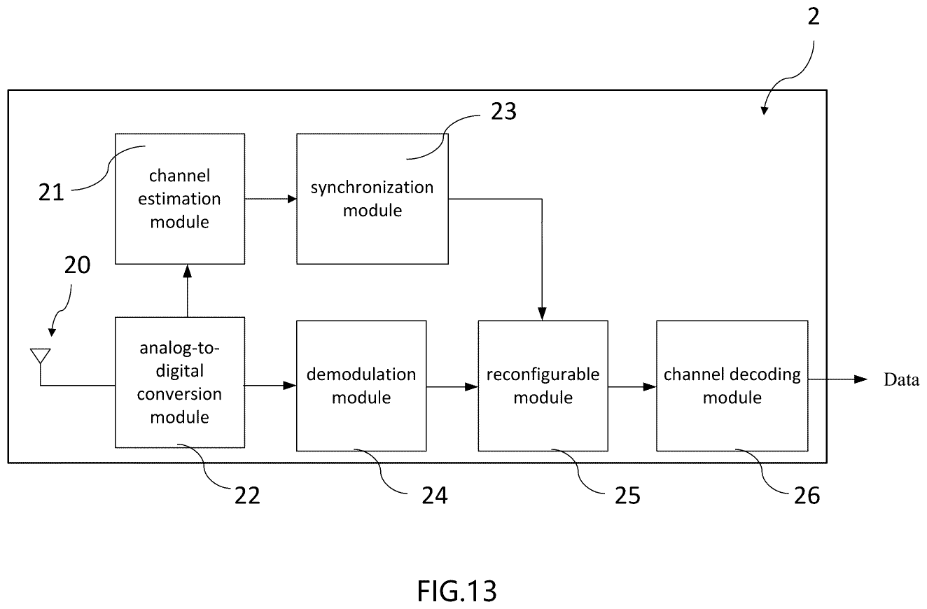

As shown in FIG. 13, in this embodiment, the signal receiving end 2 further comprises a channel estimation module 21, a synchronization module 23, and a reconfigurable module 25. The channel estimation module 21 is connected to the second antenna 20 and receives the digital multimodal composite carriers to generate channel estimation information. The synchronization module 23 is connected to the channel estimation module 21 and generates a synchronization signal based on the channel estimation information. The synchronization signal is used to determine the differences in the frequency mode, time mode, and phase angle mode, thereby achieving alignment between the signal transmitting end 1 and the signal receiving end 2 to ensure that the data can be accurately demodulation. The reconfigurable module 25 is connected to the synchronization module 23 and is placed between the demodulation module 24 and the channel decoding module 26. The reconfigurable module 25 compensates for the synchronization signal. Corrects the frequency mode, time mode, and phase angle mode of the digital multimodal composite carriers, thereby improving the decoding accuracy of the channel decoding module 26.

In this embodiment, the signal receiving end 2 feeds back channel estimation information to the signal transmitting end 1. The signal transmitting end 1 adjusts the subcarrier mode number of the multimodal composite subcarriers based on the channel estimation information. The channel coding module 10 encodes the data into channel encoded data corresponding to the adjusted subcarrier mode number. The modulation module 12 then tunes the channel encoded data onto the multimodal composite subcarriers' frequency mode, time mode, and phase mode, achieving the objective of adapting the plurality of multimodal composite carriers transmission.

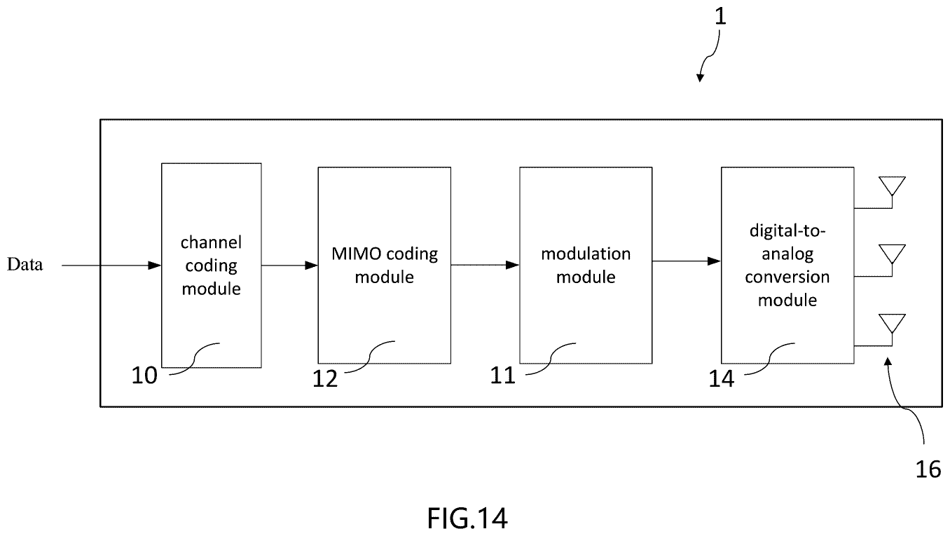

In some embodiments, as shown in FIG. 14, the signal transmitting end 1 further comprises a MIMO coding module 11 and a plurality of first antennas 16. The channel coding module 10 receives data and encodes it into channel encoded data. The MIMO coding module 11, connected to the channel coding module 10, encodes the channel encoded data into a plurality of MIMO-coded data. The modulation module 12, connected to the MIMO coding module 11, modulates the plurality of MIMO-coded data onto the plurality of multimodal composite subcarriers, and further modulates the plurality of multimodal composite subcarriers into a plurality of digital multimodal composite carriers. The digital-to-analog conversion module 14, connected to the modulation module 12, converts the plurality of digital multimodal composite carriers into a plurality of analog multimodal composite carriers. The plurality of first antennas 16, connected to the digital-to-analog conversion module 14, are configured to individually transmit one of the analog multimodal composite carriers.

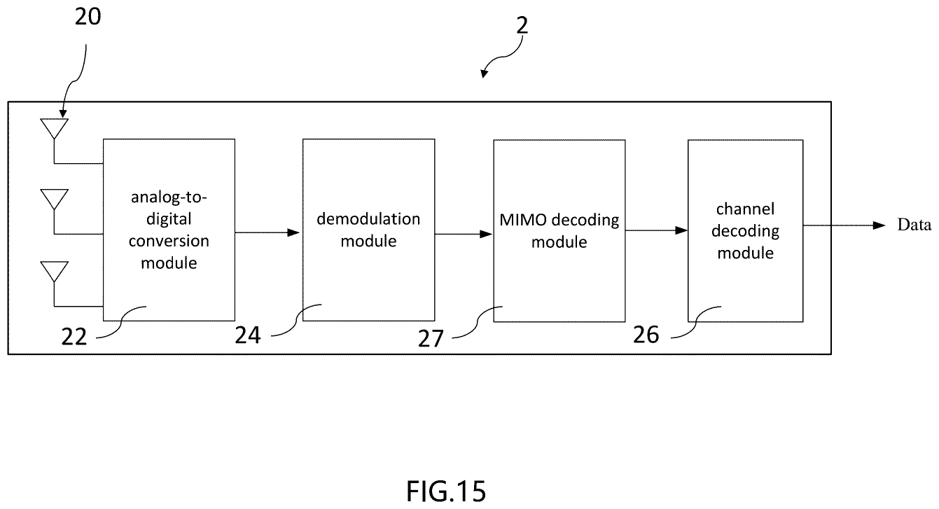

As shown in FIG. 15, the signal receiving end 2 further comprises a MIMO decoding module 27 and a plurality of second antennas 20. The plurality of second antennas 20 each individually receives one of the analog multimodal composite carriers. The analog-to-digital conversion module 22, connected to the second antennas 20, converts the analog multimodal composite carriers into the plurality of digital multimodal composite carriers. The demodulation module 24, connected to the analog-to-digital conversion module 22, demodulates the plurality of digital multimodal composite carriers into the plurality of multimodal composite subcarriers and further demodulates the plurality of multimodal composite subcarriers into the plurality of MIMO-coded data. The MIMO decoding module 27, connected to the demodulation module 24, decodes the plurality of MIMO-coded data into channel encoded data. The channel decoding module 26, connected to the MIMO decoding module 27, decodes the channel encoded data into the data.

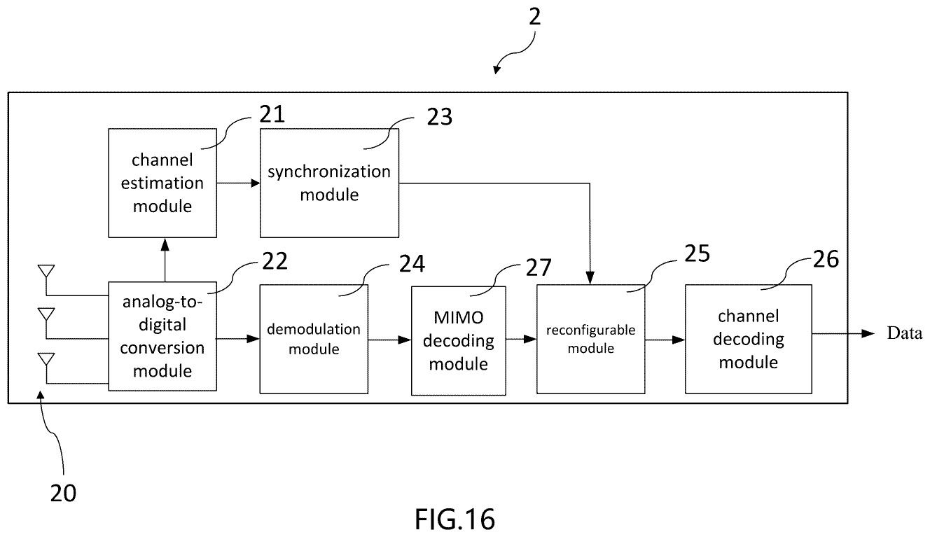

As shown in FIG. 16, the signal receiving end 2 further comprises a channel estimation module 21, a synchronization module 23, and a reconfigurable module 25. The connection and operation of the channel estimation module 21 and the synchronization module 23 are the same as in embodiments where the signal receiving end 2 does not include the MIMO decoding module 27. The reconfigurable module 25, in addition to connecting to the channel estimation module 21, is placed between the MIMO decoding module 27 and the channel decoding module 26. The reconfigurable module's function remains the same as in embodiments without the MIMO decoding module 27, so it will not be redundantly described.

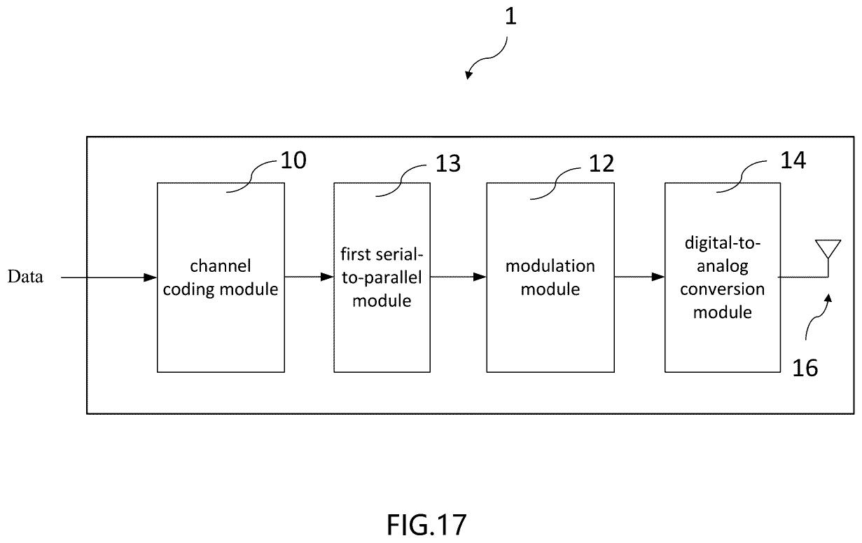

As shown in FIG. 17, in some embodiments, the channel coding module 10 performs channel coding, interleaving, and symbol mapping to generate channel encoded data. A first serial-to-parallel module 13 is provided between the channel coding module 10 and the modulation module 12. The first serial-to-parallel module 13 converts the channel encoded data into multiple sub-channel encoded data streams, which are sent to the modulation module 12 for modulation.

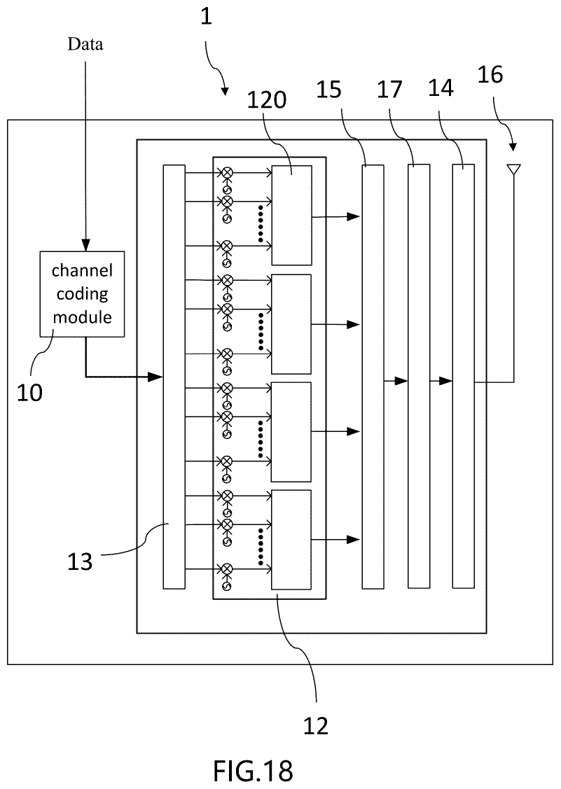

As shown in FIG. 18, in this embodiment, the modulation module 12 comprises n first communication modulation chips 120. Each first communication modulation chip 120 performs an inverse fast Fourier transform (IFFT) to modulate its respective sub-channel encoded data onto the frequency mode, time mode, and phase angle mode, forming the multimodal composite subcarriers.

For modulation into orthogonal frequency-division multiplexing in non-coherent modes (AOM), each first communication modulation chip 120 modulates its respective sub-channel encoded data into multimodal composite subcarriers that are orthogonal in frequency and time but differ in phase. The orthogonal frequency-division multiplexing in non-coherent modes can be represented as:

$$\begin{matrix}{OFDM}_{1} {Φ}_{1} , {OFDM}_{1} {Φ}_{2} , {OFDM}_{1} {Φ}_{3} … {OFDM}_{1} {Φ}_{n - 1} , {OFDM}_{1} {Φ}_{n} ; \\ {OFDM}_{2} {Φ}_{1} , {OFDM}_{2} {Φ}_{2} , {OFDM}_{2} {Φ}_{3} … {OFDM}_{2} {Φ}_{n - 1} , {OFDM}_{2} {Φ}_{n} ; {OFDM}_{3} {Φ}_{1} , {OFDM}_{3} {Φ}_{2} , {OFDM}_{3} {Φ}_{3} , … {OFDM}_{3} {Φ}_{n - 1} , {OFDM}_{3} {Φ}_{n} ; {OFDM}_{n - 1} {Φ}_{1} , {OFDM}_{n - 1} {Φ}_{2} , {OFDM}_{n - 1} {Φ}_{3} … \\ {OFDM}_{n - 1} {Φ}_{n - 1} , {OFDM}_{n - 1} {Φ}_{n} , {OFDM}_{n} {Φ}_{1} , {OFDM}_{n} {Φ}_{2} , {OFDM}_{n} {Φ}_{3} … {OFDM}_{n} {Φ}_{n - 1} , {OFDM}_{n} {Φ}_{n} .\end{matrix}$$

For modulation into non-orthogonal frequency-division multiplexing in non-coherent modes (ANM), each first communication modulation chip 120 modulates its respective sub-channel encoded data into multimodal composite subcarriers that are non-orthogonal in frequency and non-orthogonal in time but differ in phase. The non-orthogonal frequency-division multiplexing in non-coherent modes can be represented as:

$$\begin{matrix}{NOFDM}_{1} {Φ}_{1} , {NOFDM}_{1} {Φ}_{2} , {NOFDM}_{1} {Φ}_{3} … {NOFDM}_{1} {Φ}_{n - 1} , {NOFDM}_{1} {Φ}_{n} ; \\ {NOFDM}_{2} {Φ}_{1} , {NOFDM}_{2} {Φ}_{2} , {NOFDM}_{2} {Φ}_{3} … {NOFDM}_{2} {Φ}_{n - 1} , {NOFDM}_{2} {Φ}_{n} ; {NOFDM}_{3} {Φ}_{1} , {NOFDM}_{3} {Φ}_{2} , {NOFDM}_{3} {Φ}_{3} , … {NOFDM}_{3} {Φ}_{n - 1} , {NOFDM}_{3} {Φ}_{n} ; {NOFDM}_{n - 1} {Φ}_{1} , {NOFDM}_{n - 1} {Φ}_{2} , {NOFDM}_{n - 1} {Φ}_{3} … \\ {NOFDM}_{n - 1} {Φ}_{n - 1} , {NOFDM}_{n - 1} {Φ}_{n} , {NOFDM}_{n} {Φ}_{1} , {NOFDM}_{n} {Φ}_{2} , {NOFDM}_{n} {Φ}_{3} … {NOFDM}_{n} {Φ}_{n - 1} , {NOFDM}_{n} {Φ}_{n} .\end{matrix}$$

In summary, this embodiment allows the modulation module 12 to adaptively perform frequency, time, and phase modulation into either orthogonal or non-orthogonal frequency-division multiplexing in non-coherent modes based on system conditions.

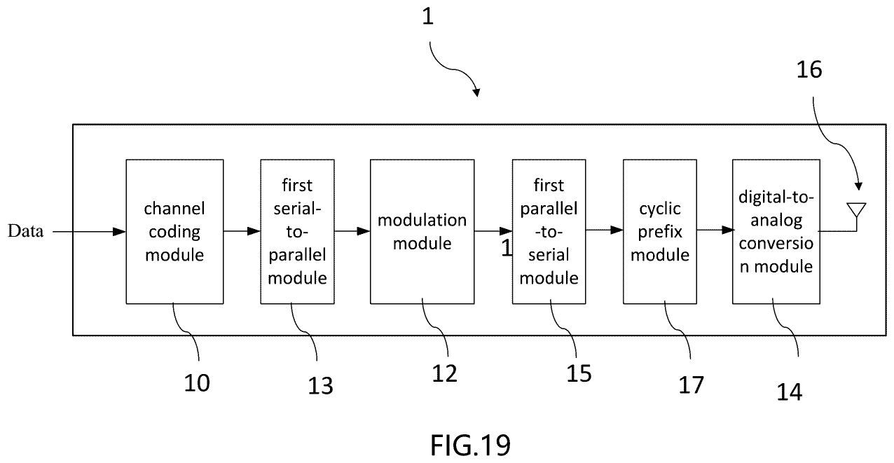

As shown in FIGS. 18 and 19, in this embodiment, a first parallel-to-serial module 15 and a cyclic prefix module 17 are provided between the modulation module 12 and the digital-to-analog conversion module 14. The first parallel-to-serial module 15 converts the parallel multimodal composite subcarriers into serial multimodal composite subcarriers. The cyclic prefix module 17 adds cyclic prefixes to the serial multimodal composite subcarriers to facilitate synchronization and channel estimation by the synchronization module 23 and the channel estimation module 21. In this embodiment, the step of modulating the plurality of multimodal composite subcarriers into the plurality of multimodal composite carriers is omitted between the cyclic prefix module 17 and the digital-to-analog conversion module 14.

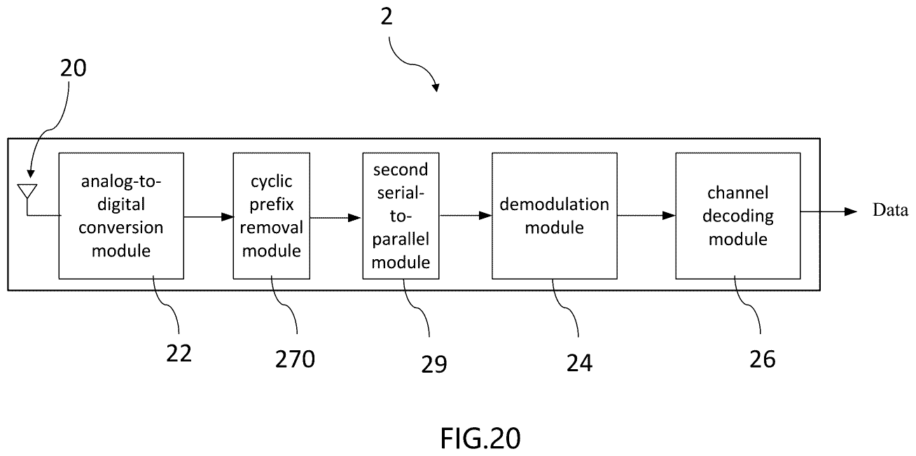

As shown in FIG. 20, in this embodiment, a cyclic prefix removal module 270 and a second serial-to-parallel module 29 are provided between the analog-to-digital conversion module 22 and the demodulation module 24. The cyclic prefix removal module 270 removes the cyclic prefixes from the received serial multimodal composite subcarriers. The second serial-to-parallel module 29, connected to the cyclic prefix removal module 270, converts the serial multimodal composite subcarriers with cyclic prefixes removed back into parallel multimodal composite subcarriers. In this embodiment, the step of demodulating the plurality of multimodal composite carriers into the plurality of multimodal composite subcarriers is omitted.

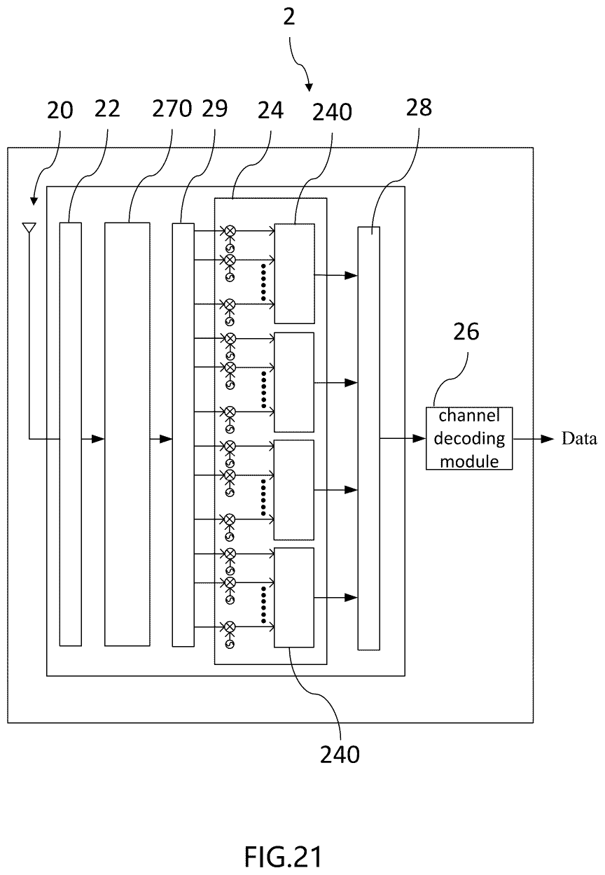

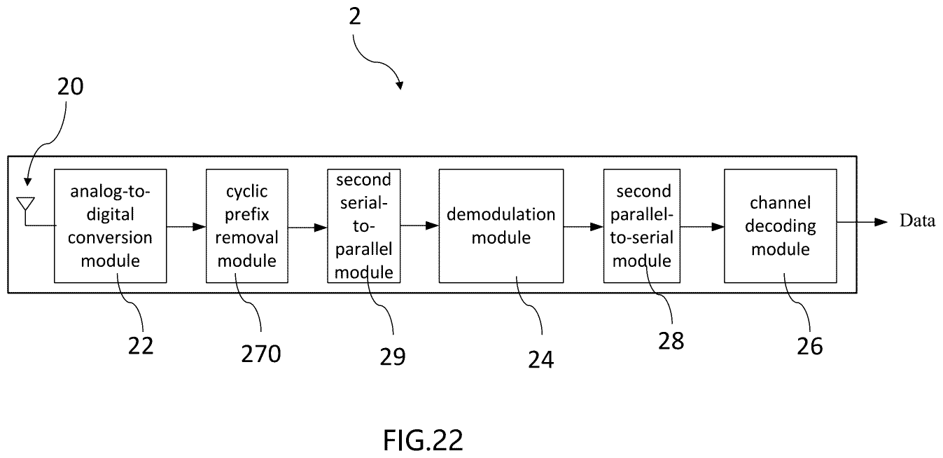

As shown in FIGS. 21 and 22, in this embodiment, the demodulation module 24 comprises n second communication modulation chips 240 where n is an integer greater than or equal to 2. Each second communication modulation chip 240 performs Fast Fourier Transform FFT on one of the parallel multimodal composite subcarriers to demodulate its frequency mode, time mode, and phase mode, converting the multimodal composite subcarriers into parallel sub-channel encoded data. In this embodiment, the step of demodulating the plurality of multimodal composite carriers into the plurality of multimodal composite subcarriers is omitted.

As shown in FIG. 22, in this embodiment, a second parallel-to-serial module 28 is provided between the demodulation module 24 and the channel decoding module 26. The second parallel-to-serial module 28 converts the parallel sub-channel encoded data into channel encoded data, which are then sent to the channel decoding module 26 for decoding. When the channel coding module 10 performs channel coding, interleaving, and symbol mapping to form channel encoded data, the channel decoding module 26 performs the corresponding channel decoding, de-interleaving, and symbol demapping to reconstruct the original data.

In summary, the present invention efficiently utilizes carrier phase resources by combining orthogonal and non-orthogonal multimodal carrier technologies, as well as other carrier techniques, to significantly improve spectral efficiency and meet future high-speed communication demands while achieving high performance and compatibility. The invention further enhances spectral efficiency, transmission stability, and anti-interference capabilities by integrating the multimodal composite subcarrier technology with real-time channel estimation, adaptive modulation, and Keren Map-based real-time monitoring. The invention dynamically adjusts the waveform parameters based on the quality of the channel, enabling backward compatibility with 5G while providing the potential for future next-generation communication systems in high-frequency bands. It offers an efficient and cost-effective solution to overcome the spectral efficiency bottleneck in wireless communication technology.

The above description merely illustrates preferred embodiments of the present invention and is not intended to limit its scope. Any simple substitutions or equivalent changes made based on the scope of the claims and the contents of this specification shall fall within the scope of the present invention.

1. A multimodal composite carrier transmission method, applied to a signal transmitting end of a communication system, comprising the steps of:
adjusting, under adaptive conditions, frequency modes, time modes, phase angle modes, and subcarrier mode numbers of a plurality of subcarriers to form a plurality of multimodal composite subcarriers;
modulating data to be transmitted onto the plurality of multimodal composite subcarriers;
modulating the plurality of multimodal composite subcarriers into a plurality of multimodal composite carriers and transmitting the plurality of multimodal composite carriers;
wherein the frequency modes, time modes, phase angle modes, and carrier mode numbers of the plurality of multimodal composite carriers are also adjusted according to the adaptive conditions.

2. The multimodal composite carrier transmission method according to claim 1, further applied to a signal receiving end of the communication system, comprising the steps of:
receiving the plurality of multimodal composite carriers, and generating synchronization information based on the received plurality of multimodal composite carriers;
adjusting, based on the synchronization information, the frequency modes, the time modes, and the phase angle modes of the received plurality of multimodal composite carriers;
demodulating the adjusted plurality of multimodal composite carriers into the plurality of multimodal composite subcarriers;
demodulating the plurality of multimodal composite subcarriers into the data.

3. The multimodal composite carrier transmission method according to claim 2, wherein the signal transmitting end and the signal receiving end are multi-input multi-output (MIMO) antenna architecture communication devices, the signal transmitting end transmits the plurality of multimodal composite carriers using MIMO antennas, and the signal receiving end receives the plurality of multimodal composite carriers using MIMO antennas.

4. The multimodal composite carrier transmission method according to claim 2, wherein in a baseband module of a modulator at the signal transmitting end, the data is modulated into N_{bf} baseband multimodal composite subcarriers, in an intermediate frequency module of the modulator, the baseband multimodal composite subcarriers are modulated into N_{if} intermediate frequency multimodal composite carriers, and in a radio frequency module of the modulator, the intermediate frequency multimodal composite carriers are modulated into N_{rf} radio frequency multimodal composite carriers, wherein the total number of mode (N) of the plurality of multimodal composite carriers is related to the baseband multimodal composite subcarriers, the intermediate frequency multimodal composite carriers, and the radio frequency multimodal composite carriers as expressed by the following relationship:
$$N = {N}_{bf} \times {N}_{if} \times {N}_{rf}$$
where N_{bf}, N_{if}, and N_{rf} are positive integers.

5. The multimodal composite carrier transmission method according to claim 2, wherein the adaptive conditions of the signal transmitting end are channel estimation of transmission channels, and based on the results of the channel estimation, the frequency modes, the time modes, the phase angle modes, and the subcarrier mode numbers of the subcarriers are adjusted.

6. The multimodal composite carrier transmission method according to claim 5, wherein the total number of modes is adjusted based on the quality of the result of the channel estimation, such that better the results of channel estimation lead to higher the subcarrier mode numbers or the total number of mode, whereas poorer the results of channel estimation lead to lower the subcarrier mode numbers or the total number of mode.

7. The multimodal composite carrier transmission method according to claim 2, wherein the plurality of multimodal composite subcarriers have identical frequency mode, identical time mode, and different phase angle mode, or the plurality of multimodal composite subcarriers have frequency orthogonal modes, continuous time orthogonal interval modes, and different phase angle modes, or the plurality of multimodal composite subcarriers have frequency non-orthogonal modes, continuous time interval modes, and different phase angle modes.

8. The multimodal composite carrier transmission method according to claim 7, wherein the plurality of multimodal composite subcarriers have the identical frequency mode and the identical time mode but different phase angle mode, and the phase interval of each phase angle mode is expressed by the following formula:
$${phash}_{angle} = \frac{180 °}{{N}_{bf \_θ}}$$
where phash_{angle} represents the phase interval of the different phase, and N_{bf_θ} represents the mode quantity of the phase mode of the multimodal composite subcarriers.

9. The multimodal composite carrier transmission method according to claim 7, wherein the frequency mode of the plurality of multimodal composite subcarriers is configured by dividing a specified bandwidth into different subbands, and arranging different transmission time intervals, subcarrier phase angle intervals, and cyclic prefixes.

10. The multimodal composite carrier transmission method according to claim 7, wherein at the signal receiving end, the synchronization information is used to determine symbol start position, carrier frequency offset, and phase drift, and to adjust frequency, time, and phase of the plurality of the multimodal composite carriers to demodulate the plurality of the multimodal composite subcarriers from the plurality of the multimodal composite carriers.

11. A multimodal composite carrier transmission system comprising:
a signal transmitting end, wherein the signal transmitting end adjusts, under adaptive conditions, frequency modes, time modes, phase angle modes, and a subcarrier mode number of a plurality of subcarriers to form a plurality of multimodal composite subcarriers, the signal transmitting end modulates data to be transmitted onto the plurality of multimodal composite subcarriers and modulates the plurality of multimodal composite subcarriers into a plurality of multimodal composite carriers for transmission; and
a signal receiving end, wherein the signal receiving end is connected to the signal transmitting end, receives the plurality of multimodal composite carriers, demodulates the plurality of multimodal composite carriers into the plurality of multimodal composite subcarriers, and demodulates the plurality of multimodal composite subcarriers into the data.

12. The multimodal composite carrier transmission system according to claim 11, wherein the signal transmitting end comprises:
a channel coding module, wherein the channel coding module receives the data and encodes the data into channel encoded data;
a modulation module, wherein the modulation module is connected to the channel coding module and modulates the channel encoded data onto the plurality of multimodal composite subcarriers and modulates the plurality of multimodal composite subcarriers into a plurality of digital multimodal composite carriers;
a digital-to-analog conversion module, wherein the digital-to-analog conversion module is connected to the modulation module and converts the plurality of digital multimodal composite carriers into a plurality of analog multimodal composite carriers; and
a first antenna, wherein the first antenna is connected to the digital-to-analog conversion module to transmit the plurality of analog multimodal composite carriers.

13. The multimodal composite carrier transmission system according to claim 12, wherein the signal receiving end comprises:
a second antenna, wherein the second antenna receives the plurality of analog multimodal composite carriers;
an analog-to-digital conversion module, wherein the analog-to-digital conversion module is connected to the second antenna and converts the plurality of analog multimodal composite carriers into the plurality of digital multimodal composite carriers;
a demodulation module, wherein the demodulation module is connected to the analog-to-digital conversion module and demodulates the plurality of digital multimodal composite carriers into the plurality of multimodal composite subcarriers, and further demodulates the plurality of multimodal composite subcarriers into the channel encoded data; and
a channel decoding module, wherein the channel decoding module decodes the channel encoded data into the data.

14. The multimodal composite carrier transmission system according to claim 13, wherein the signal receiving end further comprises:
a channel estimation module, wherein the channel estimation module is connected to the second antenna and generates channel estimation information from the multimodal composite carriers;
a synchronization module, wherein the synchronization module is connected to the channel estimation module and generates a synchronization signal based on the channel estimation information, and determines the differences in the frequency modes, the time modes, and the phase angle modes based on the synchronization signal;
an reconfigurable module, wherein the reconfigurable module is connected to the synchronization module and placed between the demodulation module and the channel decoding module, and compensates for channel distortion based on the synchronization signal to correct the frequency mode, the time modes, and the phase angle modes of d.

15. The multimodal composite carrier transmission system according to claim 14, wherein the signal receiving end feeds the channel estimation information back to the signal transmitting end, and the signal transmitting end adjusts the subcarrier mode number of the plurality of multimodal composite subcarriers based on the channel estimation information, then, the channel coding module encodes the data into the channel encoded data corresponding to the subcarrier mode number, and the modulation module tunes the channel encoded data onto the frequency modes, the time modes, and the phase modes of the plurality of multimodal composite subcarriers.

16. The multimodal composite carrier transmission system according to claim 15, wherein a first serial-to-parallel module is provided between the channel coding module and the modulation module, the first serial-to-parallel module converts the channel encoded data into a plurality of sub-channel encoded data and sends the plurality of sub-channel encoded data to the modulation module for modulation.

17. The multimodal composite carrier transmission system according to claim 16, wherein the modulation module comprises n first communication modulation chips, where n is an integer greater than or equal to 2, each of the first communication modulation chip performs an inverse fast Fourier transform (IFFT) to modulate the respective sub-channel encoded data into the frequency modes, the time modes, and the phase angle modes to form the plurality of multimodal composite subcarriers.

18. The multimodal composite carrier transmission system according to claim 16, wherein a first parallel-to-serial module and a cyclic prefix module are provided between the modulation module and the digital-to-analog conversion module, the first parallel-to-serial module converts the plurality of multimodal composite subcarriers in parallel form into serial multimodal composite subcarriers, and the cyclic prefix module, connected to the first parallel-to-serial module, adds cyclic prefixes to the serial multimodal composite subcarriers.

19. The multimodal composite carrier transmission system according to claim 18, wherein a cyclic prefix removal module and a second serial-to-parallel module are provided between the digital-to-analog conversion module and the demodulation module, the cyclic prefix removal module removes the cyclic prefixes from the serial multimodal composite subcarriers, and the second serial-to-parallel module, connected to the cyclic prefix removal module, converts the serial multimodal composite subcarriers into the plurality of multimodal composite subcarriers in parallel form.

20. The multimodal composite carrier transmission system according to claim 18, wherein the demodulation module comprises n second communication modulation chips, where n is an integer greater than or equal to 2, each of the second communication modulation chip performs a Fast Fourier Transform (FFT) on one of the plurality of multimodal composite subcarriers in parallel form to demodulate the frequency mode, the time mode, and the phase angle mode, converting the multimodal composite subcarriers into corresponding sub-channel encoded data in parallel form.

21. The multimodal composite carrier transmission system according to claim 18, wherein a second parallel-to-serial module is provided between the demodulation module and the channel decoding module, the second parallel-to-serial module converts the plurality of sub-channel encoded data in parallel form into the channel encoded data and sends the channel encoded data to the channel decoding module for decoding.
